(19) United States
(12) Patent Application Publication
(10) Pub. No.: US 2026/0238547 A1
(43) Pub. Date: Aug. 13, 2026

(54) DYNAMIC ACTIVATION OF SINGLETON SERVICE

(71) Applicant: INTERNATIONAL BUSINESS MACHINES CORPORATION, ARMONK, NY (US)

(72) Inventors: ZHI LI GUAN, BEIJING (CN); Guo Liang Huang, Beijing (CN); Fang Tai Li, BEIJING (CN); Yun Diao, Beijing (CN); Hai Wei Fang, Tianjin (CN); Shi Su, BEIJING (CN)

(21) Appl. No.: 19/051,249

(22) Filed: Feb. 12, 2025

(51) Int. Cl. H04L 41/0823; H04L 43/10

(52) U.S. Cl. CPC H04L 41/0823; H04L 43/10

(57) ABSTRACT

A method, computer program product, and computer system for dynamically changing an endpoint of a singleton service. The endpoint is a network address of a pod that provides the singleton service. It is determined that a first pod of multiple pods is unavailable. It is ascertained that the singleton service’s endpoint is a network address of the first pod. In response to the ascertaining, a second pod of the multiple pods is selected as a next provider of the singleton service and the singleton service’s endpoint is replaced with the network address of the second pod.

### BACKGROUND

The present invention relates to a singleton service in a container orchestration system, and more specifically, to dynamically changing an endpoint of the singleton service.

### SUMMARY

Embodiments of the present invention provide a method, a computer program product, and a computer system, for dynamically changing an endpoint of a singleton service, said endpoint being a network address of a pod that provides the singleton service. The method: (i) determines that a first pod of multiple pods is unavailable; (ii) ascertains that the singleton service’s endpoint is a network address of the first pod; and (iii) in response to ascertaining that the singleton service’s endpoint is a network address of the first pod, a second pod of the multiple pods is selected as a next provider of the singleton service and replaces the singleton service’s endpoint with the network address of the second pod.

### BRIEF DESCRIPTION OF THE DRAWINGS

FIG. 1 depicts a Kubernetes cluster, in accordance with embodiments of the present invention.

FIG. 2 depicts a worker node which represents any worker node of worker nodes depicted in FIG. 1, in accordance with embodiments of the present invention.

FIG. 3 depicts a pod which represents any pod of depicted one or more pods in FIG. 2, in accordance with embodiments of the present invention.

FIG. 4 depicts a configuration of pods within the Kubernetes cluster, in accordance with embodiments of the present invention.

FIG. 5 is a flowchart of a process for managing a singleton service endpoint, in accordance with embodiments of the present invention.

FIG. 6 is a flow chart of a method for dynamically changing an endpoint of a singleton service, in accordance with embodiments of the present invention.

FIG. 7 is a flow chart of a process for determining that a first pod of multiple pods is unavailable, in accordance with embodiments of the present invention.

FIG. 8 is a chart depicting alternative processes for selecting the second pod as the next provider of singleton service, in accordance with embodiments of the present invention.

FIG. 9 is a flow chart describing a process in which the singleton service’s endpoint in the persistent store has changed, in accordance with embodiments of the present invention.

FIG. 10 is a flow chart describing an exemplary case that implements the process of FIG. 9, in accordance with embodiments of the present invention.

FIG. 11 is a flow chart of a process occurring after the first pod, which was previously unavailable, is now available, in accordance with embodiments of the present invention.

FIG. 12 is a flow chart describing a starting up of each pod of the multiple pods wherein the singleton service’s endpoint is not initially in the persistent store, in accordance with embodiments of the present invention.

FIG. 13 illustrates a computer system, in accordance with embodiments of the present invention.

FIG. 14 depicts a computing environment which contains an example of an environment for the execution of at least some of the computer code involved in performing the inventive methods, in accordance with embodiments of the present invention.

### DETAILED DESCRIPTION

Kubernetes (abbreviated as K8s) is a portable, extensible, open source platform for managing, deploying, and scaling containerized workloads and services, and facilitates both declarative configuration and automation. Although reference is made to Kubernetes and Kubernetes specific elements, embodiments of the present invention are not limited to the Kubernetes environment, and that embodiments of the present invention may be practiced using any type of container orchestration environment, platform, architecture, or the like.

A Kubernetes cluster is a group of nodes (machines) that Kubernetes uses to run containerized applications.

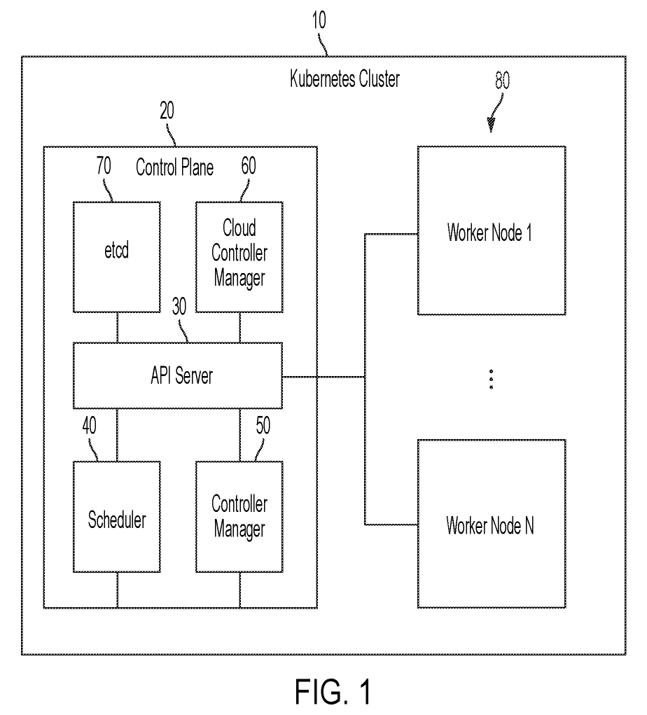

FIG. 1 depicts a Kubernetes cluster 10, in accordance with embodiments of the present invention. The Kubernetes cluster 10 includes a control plane 20 and worker nodes 80.

The control plane 20 operates in a master node which is a physical or virtual machine where the control plane components are executed.

The control plane 20 includes an Application Programming Interface (API) server 30, a scheduler 40, a controller manager 50, a cloud controller manager 60, and an etcd 70.

The API server 30 is a central component through which all other Kubernetes components in the Kubernetes cluster 10 interact and is configured to communicate with all other components in the Kubernetes cluster 10.

The scheduler 40 assigns pods to nodes based on resource availability and constraints.

The controller manager 50 manages controllers that handle tasks such as ensuring that a desired number of pods are running.

The cloud controller manager 60 integrates Kubernetes with an underlying cloud. provider.

The etcd 70 is a key-value store for cluster state and configuration data.

The worker nodes 80 include N worker nodes, namely, worker node 1, …, worker node N, wherein N is at least 2.

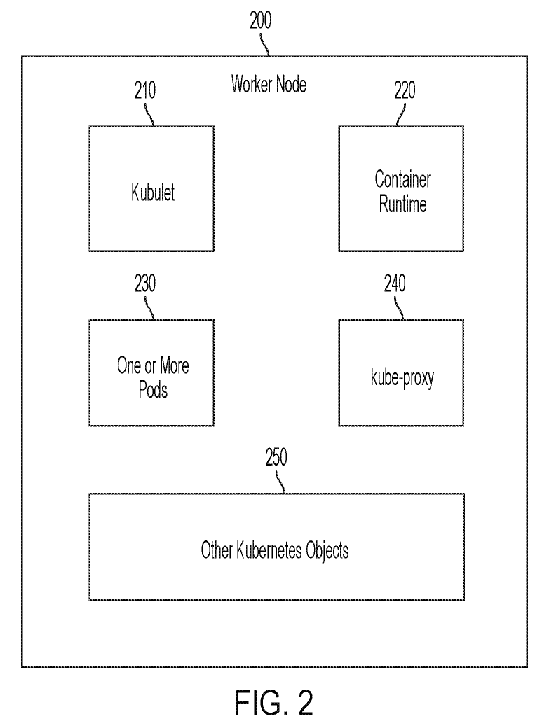

FIG. 2 depicts a worker node 200 which represents any worker node of the worker nodes 80 in FIG. 1, in accordance with embodiments of the present invention.

The worker node 200 includes, inter alia, kubulet 210, container runtime 220, one or more pods 230, kube-proxy 240, and other Kubernetes objects 250.

The kubulet 210 manages the worker node 200 and communicates with the control plane 20.

The container runtime 220 performs container image management, container execution, networking, and storage, and provides isolation and resource management required by containers.

Each pod of the one or more pods 230 includes one or more containers, provides a shared execution environment for containers, and serves as a logical host for the containers that are deployed together on the same worker node. The shared execution environment includes shared network and storage resources. A pod is the smallest deployable unit of computing that can be created in Kubernetes.

All containers in a pod share the same network namespace and Internet Protocol (IP) address. Each Pod can include one or more volumes for data storage. These volumes are mounted into the containers and enable sharing data between containers in the same pod.

The kube-proxy 240 handles network communication for the one or more pods 230.

Other Kubernetes objects 250 may include, inter alia, Deployment (manages identical pods and ensures that the identical pods run with a desired state, and supports rolling updates and rollback), ReplicaSet (ensures that a specific number of pod replicas are running at any given time), StatefulSet (used for stateful applications such as databases, where each pod needs a unique identity and stable storage), DaemonSet (ensures that a copy of a pod runs on all nodes in the cluster), Job (manages execution of a single task or a batch of tasks until completion), CronJob (a job that runs on a schedule), Service (exposes a set of pods as a network service, enabling communication between applications), Endpoint (tracks network addresses of pods targeted by a service), ConfigMap (used to store non-sensitive configuration data in key-value pairs), Secret (used to store sensitive data such as passwords, tokens, or keys, securely), PersistentVolume (represents storage in the cluster), PersistentVolumeClaim (a request for storage by a user), StorageClass (defines the types of storage available in the cluster), Namespace (provides a way to create isolated environments within a cluster), etc.

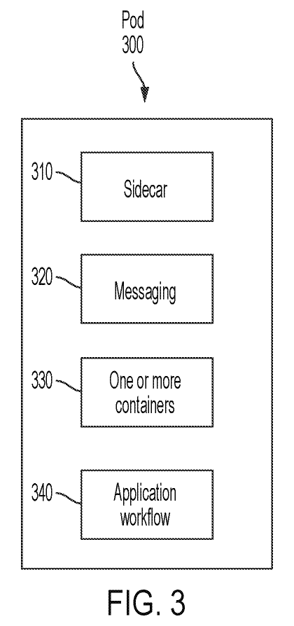

FIG. 3 depicts a pod 300 which represents any pod of the one or more pods 230 in FIG. 2, in accordance with embodiments of the present invention.

Pod 300 includes, inter alia, a sidecar 310, messaging, 320, one or more containers 330, and application workflow, 340.

The sidecar 310 is a container, which is in addition to the one or more containers 330, that can perform tasks such as syncing data from a remote source, collecting and shipping logs, providing health checks and metrics, proxying network traffic, encrypting or decrypting data, etc. Providing health checks and metrics includes providing health checks and metrics of the other pods of the one or more pods in the worker node comprising the pod 300, or of the pods within any other worker nodes.

Messaging 320 refers to how the one or more containers 330 running inside the pod 300 communicate with each other or with other pods, services, or external systems.

The one or more containers 330 are each an application that contains all the dependencies required to run the application.

The application workflow 340 refers to the sequence of tasks or processes that an application performs while running inside the pod.

The Kubernetes cluster 10 includes a singleton service which is a service that ensures there is only one active instance of a specific component or workload at any given time which may is achieved by running a single pod in the cluster hosting (i.e., implementing) the singleton service to guarantee exclusivity of the singleton service. The single pod is the only pod instance that is active at any time.

If the single pod hosting the singleton becomes unavailable (e.g., by failing), then another pod that is available is selected to replace the single pod to host the singleton service.

The pod that hosts the singleton service is called a “host pod”. The endpoint of a singleton service is an address (e.g., an IP address or a universal resource locator (URL)) at which a shared instance of the singleton service can be interacted with. The endpoint of a singleton service is a function of the host pod and is alternatively called a “host address”. In one embodiment, the host address is an address of the host pod.

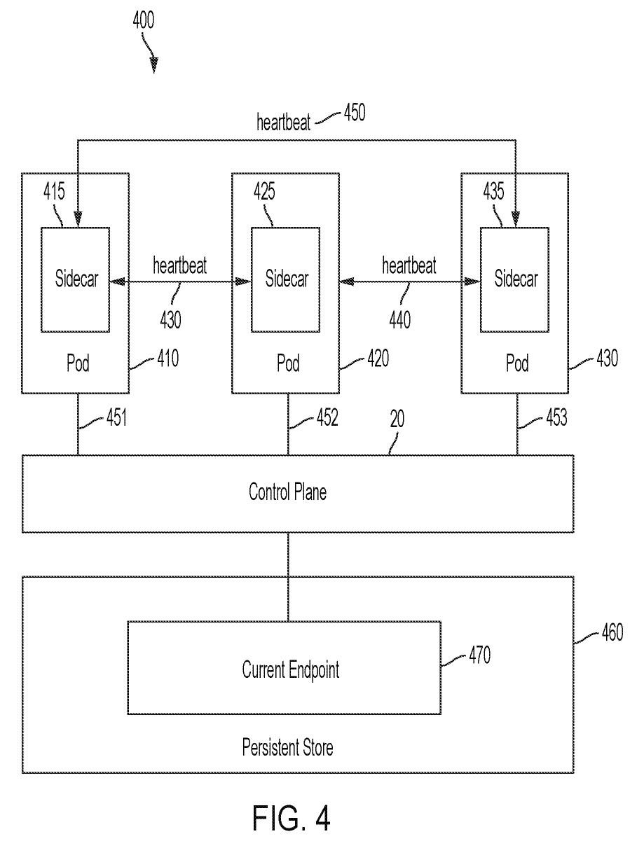

The current endpoint of a singleton service is stored in a persistent store (e.g., the persistent store 440 in FIG. 4) and is dynamically updated as the endpoint of a singleton service changes. A persistent store is a data storage system that retains data even after the data storage system is powered off or restarted, which ensures that data is not lost when the application or device is shut down.

FIG. 4 depicts a configuration 400 of pods 410, 420 and 430 within the Kubernetes cluster 10, in accordance with embodiments of the present invention.

The pods 410, 420 and 430 are any pods in the worker nodes 80. In one embodiment, the pods 410, 420 and 430 are pods in one worker node of the worker nodes 80. In one embodiment, the pods 410, 420 and 430 are pods distributed in multiple worker nodes of the worker nodes 80.

The pods 410, 420 and 430 include sidecars 415, 425 and 435, respectively, and may include other objects which are not shown in FIG. 4.

The persistent store 460 is storing the current endpoint 470 of a singleton service.

Each sidecar periodically exchanges a heartbeat with each other pod. Specifically, Sidecars 415 and 425 exchange heartbeat 430 with each other, sidecars 425 and 435 exchange heartbeat 440 with each other, and sidecars 415 and 435 exchange heartbeat 450 with each other.

A heartbeat is a periodic signal exchanged between two pods to indicate an availability, health, or status of the two pods. The heartbeat signals are used for maintaining the cluster’s operational integrity and ensuring that the pods are properly functioning and available.

In one embodiment, the control plane 20 receives the periodic heartbeats (430, 440, 450) from the pods 415, 425 and 435 via communication links 451, 452 and 453, respectively, and the control plane 20 analyzes the heartbeats and selects a next host pod as illustrated in the following example.

Assume that the current host pod is pod 410, so that the current endpoint 470 in the persistent store 460 is the host address of the host pod 410. If it is inferred from the heartbeats 430 and/or 450 that pod 410 is unavailable, and if pods 420 and 430 are available, then pod 420 or pods 430 will be selected to replace pod 410 as the next host pod to host the singleton service, and the address of the next host pod will become the current endpoint 470 in the persistent store 460.

Assume that pods 410, 420 and 430 have been assigned priorities p1, p2 and p3 (e.g., p1=1, p2=2, p3=3), respectively, for being the next host pod.

In one embodiment, pod 420 is selected as the next host pod if p2 > p3, pod 430 is selected as the next host pod if p3 > p2, or the next host pod is randomly selected from pods 420 and 430 with equal probability of being selected if p2 = p3, or the next host pod is randomly selected from pods 420 and 430 with a weighted probability wherein the weight for each pod is proportional to the priority of each pod.

For example for the preceding weighted probability embodiment, the next host pod is randomly selected from pods 420 and 430 with a probability of selecting pod 420 equal to p2/(p2+p3) and a probability of selecting pod 430 equal to p3/(p2+p3).

In one embodiment, the next host pod is randomly selected from pods 420 and 430 with equal probability of being selected independent of the assigned priorities.

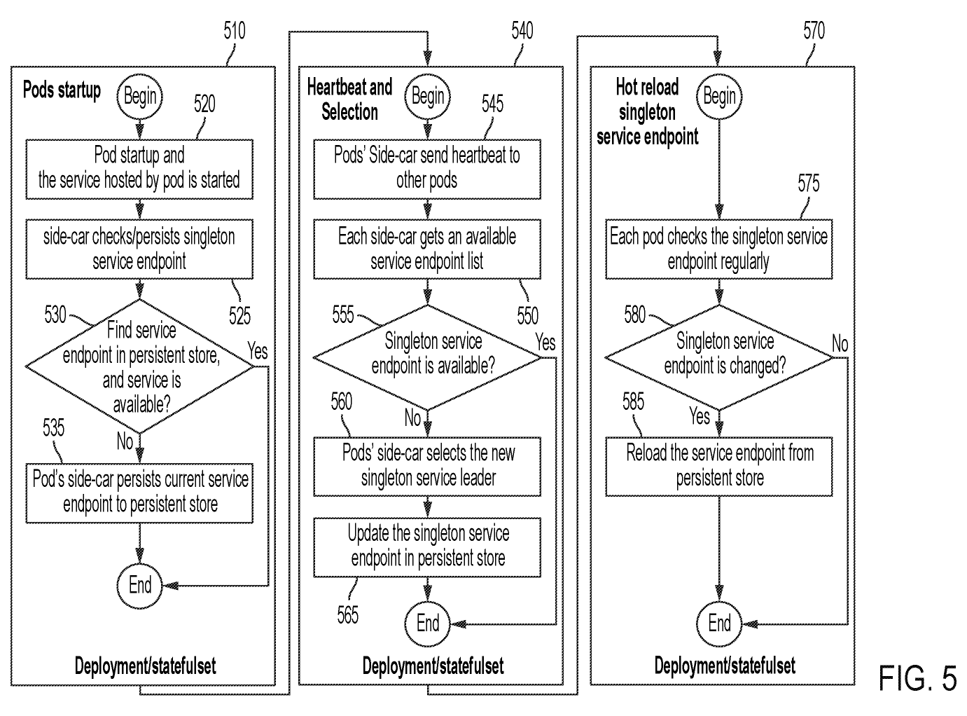

FIG. 5 is a flowchart of a process for managing a singleton service endpoint, in accordance with embodiments of the present invention. The flow chart of FIG. 5 includes sequentially ordered sub-processes 510, 540 and 570. Sub-process 510 pertains to a startup of pods. Sub-process 540 uses heartbeats to select a replacement for a singleton service endpoint. Subprocess 570 performs a hot reload of a singleton service endpoint.

In one embodiment, each pod includes a stateful application that provides the singleton service, wherein a statefulset workload resource manages each pod.

In one embodiment, each pod includes a stateless application that provides the singleton service, wherein a deployment workload resource manages each pod.

An endpoint is a network address of a pod that provides the singleton service.

Sub-process 510, which pertains to a startup of pods, includes steps 520-535.

Step 520 performs a pod startup, wherein the service hosted by each pod is started.

In step 525, a sidecar in each pod checks to determine whether the singleton service endpoint exists.

Step 530 find a singleton service endpoint in the persistent store and determines whether the singleton service is available. If so (Yes branch from step 530) then the sub-process 510 ends. If not (No branch from step 530) then step 535 is next executed.

The singleton service is available if the singleton service is reachable and functional, allowing requests to be sent to the pod that provides the singleton service and responses to be received from the pod that provides the singleton service.

In step 535, the pod’s sidecar persists (i.e., stores) the current singleton service endpoint to the persistent store, after which the sub-process 510 ends.

Sub-process 540, which uses heartbeats to select a replacement for a singleton service endpoint, includes steps 545-565.

In step 545, each sidecar sends a heartbeat to the sidecar in each other pod.

In step 550, the sidecar in each pod obtains an available service endpoint list.

Step 555 determines whether a singleton service endpoint is available. If so (Yes branch from step 555) then the sub-process 540 ends. If not (No branch from step 555) then step 560 is next executed.

A singleton service endpoint is available if the host pod that provides the singleton service satisfies the conditions required for the host pod to handle traffic which may include satisfying readiness probe checks, resource availability, and overall pod health.

In step 560, the sidecars of the pods select a new pod that will provide the singleton service.

Step 565 replaces the singleton service endpoint in the persistent store with the endpoint of the new pod, after which the sub-process 540 ends.

Sub-process 570, which performs a hot reload of a singleton service endpoint, includes steps 575-585.

In step 575, each pod checks the singleton service endpoint regularly.

Step 580 determines whether the singleton service endpoint has changed. If not (No branch from step 580) then the sub-process 570 ends. If so (Yes branch from step 580) then step 585 is next executed.

Step 585 reloads the singleton service endpoint from the persistent store, after which the sub-process 570 ends.

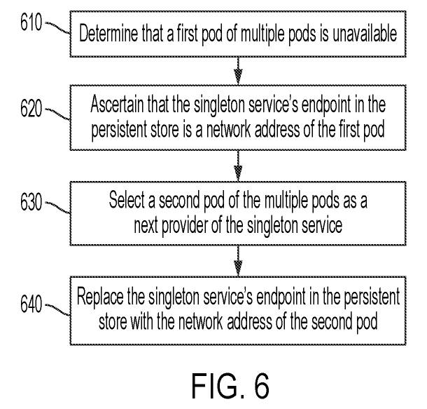

FIG. 6 is a flow chart of a method for dynamically changing an endpoint of a singleton service, in accordance with embodiments of the present invention. An endpoint is a network address of a pod that provides the singleton service. The flow chart of FIG. 6 includes steps 610-640.

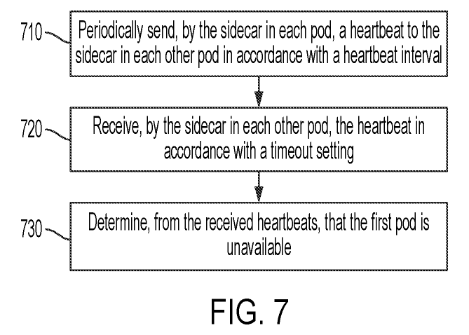

Step 610 determines that a first pod of multiple pods is unavailable. A Kubernetes system comprises the multiple pods and a persistent store. Each pod comprises a sidecar. The persistent store stores the singleton service’s endpoint. Step 610 is described in more detail in FIG. 7

Step 620 ascertains that the singleton service’s endpoint in the persistent store is a network address of the first pod.

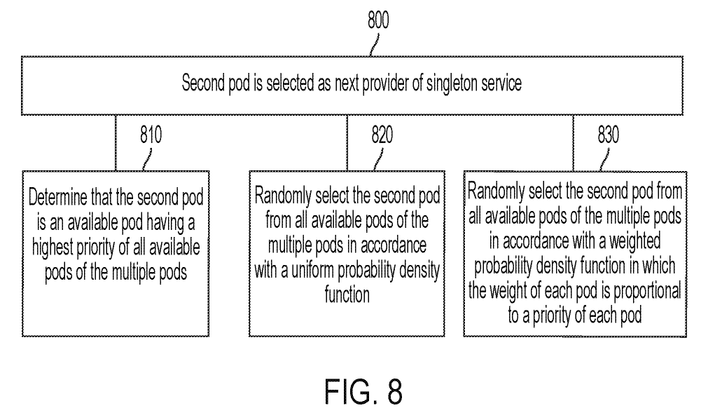

In response to step 620, it is ascertained that the singleton service’s endpoint in the persistent store is a network address of the first pod, and step 630 selects a second pod of the multiple pods as a next provider of the singleton service, and step 640 replaces the singleton service’s endpoint in the persistent store with the network address of the second pod. FIG. 8 presents alternative processes for implementing step 630.

FIG. 7 is a flow chart of a process for determining that a first pod of multiple pods is unavailable, in accordance with embodiments of the present invention. FIG. 7, which describes step 610 of FIG. 6 in more detail, includes steps 710-730.

A pod is available if the pod satisfies the conditions required for the pod to handle traffic which may include satisfying readiness probe checks, resource availability, and overall pod health. A pod is unavailable if the pod is not available.

Step 710 periodically sends, by the sidecar in each pod to the sidecar in each other pod, a heartbeat in accordance with a heartbeat interval.

The heartbeat interval is a frequency at which the sidecar sends the heartbeat signal to another sidecar.

In step 720, the sidecar in each other pod receives the heartbeat in accordance with a timeout setting.

A timeout setting is a maximum period of time that heartbeat-receiving sidecar waits to receive the heartbeat before considering the pod whose sidecar sent the heartbeat to be unresponsive or unhealthy and thus unavailable.

Step 730 determines, from the received heartbeats, that the first pod is unavailable.

In one embodiment, the sidecar in one pod of the multiple pods determines from the received heartbeats that the first pod is unavailable, wherein the sidecar in the one pod performs both selection of the second pod as the next provider of the singleton service and replacement of the singleton service's endpoint in the persistent store with the network address of the second pod.

In one embodiment, each pod sends each pod’s received heartbeat to the control plane wherein the control plane determines from the received heartbeats that the first pod is unavailable, wherein the control plane performs both selection of the second pod as the next provider of the singleton service and replacement of the singleton service's endpoint in the persistent store with the network address of the second pod.

FIG. 8 is a chart depicting alternative processes for selecting the second pod as the next provider of singleton service, in accordance with embodiments of the present invention. FIG. 8, which implements step 630 of FIG. 6, describes the alternative processes 810, 820 and 830.

Process 810 determines that the second pod is an available pod having a highest priority of all available pods of the multiple pods.

Process 820 randomly selects the second pod from all available pods of the multiple pods in accordance with a uniform probability density function.

Process 830 randomly selects the second pod from all available pods of the multiple pods in accordance with a weighted probability density function in which the weight of each pod is proportional to a priority of each pod.

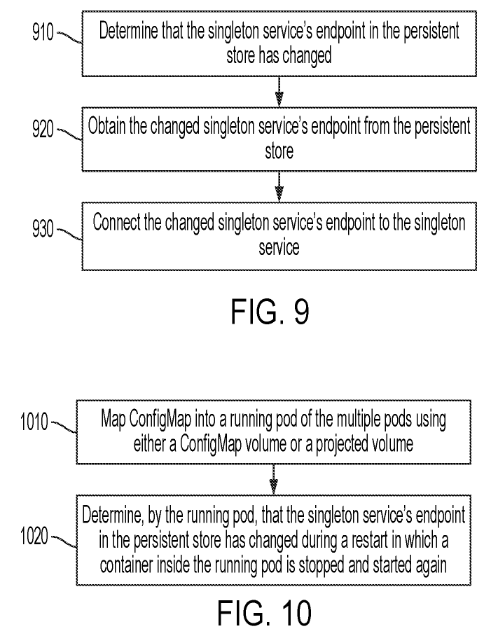

FIG. 9 is a flow chart describing a process in which the singleton service’s endpoint in the persistent store has changed, in accordance with embodiments of the present invention. The flow chart of FIG. 9 includes steps 910-930.

Step 910 determines that the singleton service’s endpoint in the persistent store has changed and in response, a hot reload (i) obtains the changed singleton service’s endpoint from the persistent store in step 920 and (ii) connects the changed singleton service’s endpoint to the singleton service in step 930.

FIG. 10 is a flow chart describing an exemplary case that implements the process of FIG. 9, in accordance with embodiments of the present invention. The flow chart of FIG. 10 includes steps 1010-1020.

In step 1010, wherein ConfigMap is used as the persistent store and the Configmap is mapped into a running pod of the multiple pods using either a Configmap volume or a projected volume. ConfigMap is a storage object that stores non-sensitive configuration data in key-value pairs.

In step 1020, the running pod determines that the singleton service’s endpoint in the persistent store has changed during a restart in which a container inside the running pod is stopped and started again.

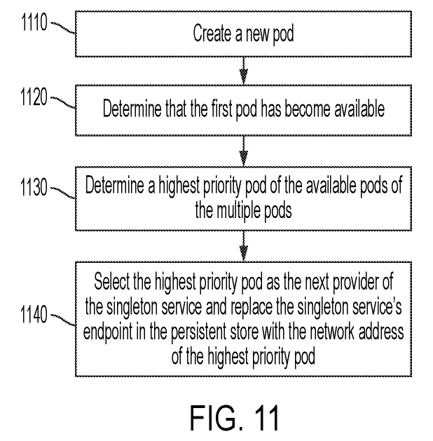

FIG. 11 is a flow chart of a process occurring after the first pod, which was previously unavailable, is now available, in accordance with embodiments of the present invention. The flow chart of FIG. 11 includes steps 1110-1140.

In step 1110, a new pod is created and is comprised by the multiple pods.

Step 1120 determines that the first pod has become available.

Step 1130 determines a highest priority pod of the available pods of the multiple pods.

Step 1140 selects the highest priority pod as the next provider of the singleton service and replaces the singleton service’s endpoint in the persistent store with the network address of the highest priority pod.

In one embodiment, in response to a determination that the first pod has a higher priority than the second pod and has a higher priority than any other available pod of the multiple pods, the first pod is selected as the next provider of the singleton service and the singleton service’s endpoint in the persistent store is replaced with the network address of the first pod.

In one embodiment, in response to a determination that the second pod has a higher priority than the first pod and has a higher priority than any other available pod of the multiple pods, then the singleton service’s endpoint in the persistent store is not changed and remains as the network address of the second pod.

In one embodiment, it is determined that the newly created pod has a higher priority than any other available pod of the multiple pods and in response, the newly created pod is selected as the next provider of the singleton service and the singleton service’s endpoint in the persistent store is replaced with the network address of the newly created pod.

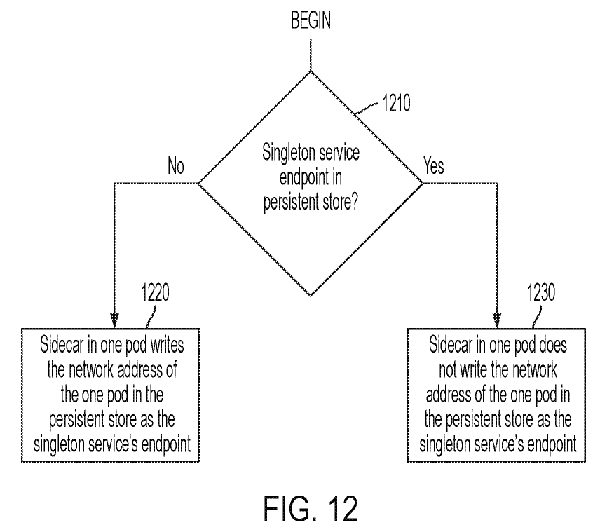

FIG. 12 is a flow chart describing a starting up of each pod of the multiple pods wherein the singleton service’s endpoint is not initially in the persistent store, in accordance with embodiments of the present invention. The flow chart of FIG. 12 includes steps 1210-1230 which pertains to initially starting up each pod of the multiple pods.

Step 1210 determines, by the sidecar in each pod, whether the singleton service’s endpoint is in the persistent store. If not (No branch from step 1210), then step 1220 is next executed. If so (Yes branch from step 1210), then step 1230 is next executed.

In response to the sidecar in one pod determining that the singleton service’s endpoint is not in the persistent, step 1220 writes, by the sidecar in the one pod, the network address of the one pod in the persistent store as the singleton service's endpoint.

In response to the sidecar in one pod determining that the singleton service’s endpoint is in the persistent, step 1230 does not write the network address of the one pod in the persistent store as the singleton service's endpoint.

In step 1230, the sidecar in one pod not write the network address of the one pod in the persistent store as the singleton service's endpoint.

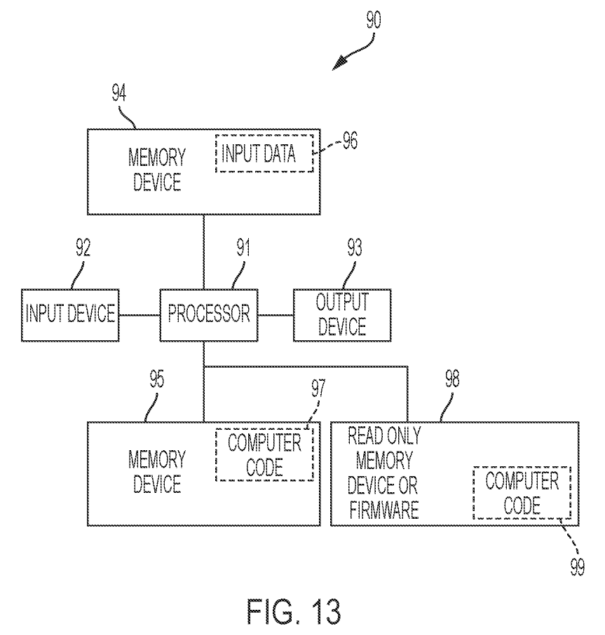

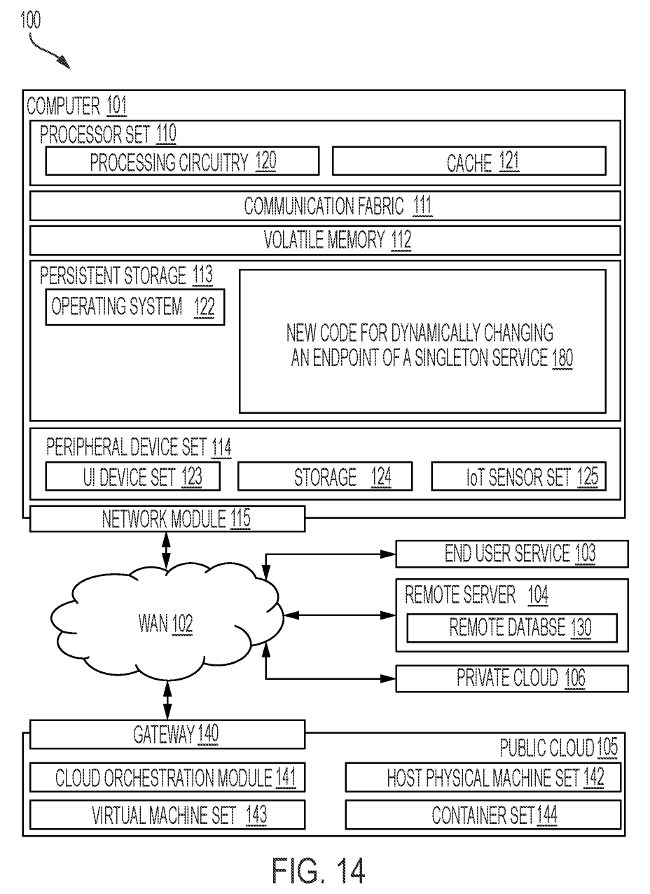

FIG. 13 illustrates a computer system 90, in accordance with embodiments of the present invention.

The computer system 90 includes a processor 91, an input device 92 coupled to the processor 91, an output device 93 coupled to the processor 91, and memory devices 94 and 95 each coupled to the processor 91. The processor 91 represents one or more processors and may denote a single processor or a plurality of processors. The input device 92 may be, inter alia, a keyboard, a mouse, a camera, a touchscreen, etc., or a combination thereof. The output device 93 may be, inter alia, a printer, a plotter, a computer screen, a magnetic tape, a removable hard disk, a floppy disk, etc., or a combination thereof. The memory devices 94 and 95 may each be, inter alia, a hard disk, a floppy disk, a magnetic tape, an optical storage such as a compact disc (CD) or a digital video disc (DVD), a dynamic random access memory (DRAM), a read-only memory (ROM), etc., or a combination thereof. The memory device 95 includes a computer code 97. The computer code 97 includes algorithms for executing embodiments of the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices such as read only memory device 96) may include algorithms and may be used as a computer usable medium (or a computer readable medium or a program storage device) having a computer readable program code embodied therein and/or having other data stored therein, wherein the computer readable program code includes the computer code 97. Generally, a computer program product (or, alternatively, an article of manufacture) of the computer system 90 may include the computer usable medium (or the program storage device).

In some embodiments, rather than being stored and accessed from a hard drive, optical disc or other writeable, rewriteable, or removable hardware memory device 95, stored computer program code 99 (e.g., including algorithms) may be stored on a static, nonremovable, read-only storage medium such as a Read-Only Memory (ROM) device 98, or may be accessed by processor 91 directly from such a static, nonremovable, read-only medium 98. Similarly, in some embodiments, stored computer program code 99 may be stored as computer-readable firmware, or may be accessed by processor 91 directly from such firmware, rather than from a more dynamic or removable hardware data-storage device 95, such as a hard drive or optical disc.

Still yet, any of the components of the present invention could be created, integrated, hosted, maintained, deployed, managed, serviced, etc. by a service supplier who offers to improve software technology associated with cross-referencing metrics associated with plug-in components, generating software code modules, and enabling operational functionality of target cloud components. Thus, the present invention discloses a process for deploying, creating, integrating, hosting, maintaining, and/or integrating computing infrastructure, including integrating computer-readable code into the computer system 90, wherein the code in combination with the computer system 90 is capable of performing a method for enabling a process for improving software technology associated with cross-referencing metrics associated with plug-in components, generating software code modules, and enabling operational functionality of target cloud components. In another embodiment, the invention provides a business method that performs the process steps of the invention on a subscription, advertising, and/or fee basis. That is, a service supplier, such as a Solution Integrator, could offer to enable a process for improving software technology associated with cross-referencing metrics associated with plug-in components, generating software code modules, and enabling operational functionality of target cloud components. In this case, the service supplier can create, maintain, support, etc. a computer infrastructure that performs the process steps of the invention for one or more customers. In return, the service supplier can receive payment from the customer(s) under a subscription and/or fee agreement and/or the service supplier can receive payment from the sale of advertising content to one or more third parties.

While FIG. 13 shows the computer system 90 as a particular configuration of hardware and software, any configuration of hardware and software, as would be known to a person of ordinary skill in the art, may be utilized for the purposes stated supra in conjunction with the particular computer system 90 of FIG. 13. For example, the memory devices 94 and 95 may be portions of a single memory device rather than separate memory devices.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 14 depicts a computing environment 100 which contains an example of an environment for the execution of at least some of the computer code involved in performing the inventive methods, in accordance with embodiments of the present invention. Such computer code includes new code for dynamically changing an endpoint of a singleton service 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input / output ports and the like. Other types of signal communication paths may be used, such as fiber optic communication paths and/or wireless communication paths

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for dynamically changing an endpoint of a singleton service, said endpoint being a network address of a pod that provides the singleton service, said method comprising:
determining that a first pod of multiple pods is unavailable;
ascertaining that the singleton service’s endpoint is a network address of the first pod; and
in response to said ascertaining, selecting a second pod of the multiple pods as a next provider of the singleton service and replacing the singleton service’s endpoint with the network address of the second pod.

2. The method of claim 1, wherein a heartbeat is sent periodically, by a sidecar in each pod, to the sidecar in each other pod in accordance with a heartbeat interval and is received by the sidecar in each other pod in accordance with a timeout setting, wherein said determining that the first pod is unavailable comprises:
determining, from the received heartbeats, that the first pod is unavailable.

3. The method of claim 2, wherein the sidecar in one pod of the multiple pods determines from the received heartbeats that the first pod is unavailable, wherein the sidecar in the one pod performs both said selecting the second pod as the next provider of the singleton service and said replacing the singleton service's endpoint with the network address of the second pod.

4. The method of claim 2, wherein each pod sends each pod’s received heartbeat to a control plane, and the control plane determines from the received heartbeats that the first pod is unavailable, wherein the control plane performs both said selecting the second pod as the next provider of the singleton service and said replacing the singleton service's endpoint with the network address of the second pod.

5. The method of claim 1, wherein said selecting the second pod comprises:
determining that the second pod is an available pod having a highest priority of all available pods of the multiple pods.

6. The method of claim 1, wherein said selecting the second pod comprises:
randomly selecting the second pod from all available pods of the multiple pods in accordance with a uniform probability density function.

7. The method of claim 1, wherein said selecting the second pod comprises:
randomly selecting the second pod from all available pods of the multiple pods in accordance with a weighted probability density function in which a weight of each pod is proportional to a priority of each pod.

8. The method of claim 1, wherein the method further comprises:
determining that the singleton service’s endpoint in a persistent store has changed and in response, performing a hot reload that obtains the changed singleton service’s endpoint from the persistent store and connects the changed singleton service’s endpoint to the singleton service.

9. The method of claim 8, wherein ConfigMap is used as the persistent store, wherein the ConfigMap is mapped into a running pod of the multiple pods using either a ConfigMap volume or a projected volume, and wherein the running pod determines that the singleton service’s endpoint in the persistent store has changed during a restart in which a container inside the running pod is stopped and started again.

10. The method of claim 1, wherein after said replacing the singleton service’s endpoint with the network address of the second pod, the first pod becomes available, and wherein the method further comprises:
in response to a determination that the first pod has a higher priority than the second pod and has a higher priority than any other pod of the multiple pods, then selecting the first pod as the next provider of the singleton service and replacing the singleton service’s endpoint with the network address of the first pod; or
in response to a determination that the second pod has a higher priority than the first pod and has a higher priority than any other available pod of the multiple pods, then not changing the singleton service’s endpoint.

11. The method of claim 1, wherein the multiple pods include a newly created pod and in response, the method further comprises:
determining that the newly created pod has a higher priority than any other available pod of the multiple pods and in response, selecting the newly created pod as the next provider of the singleton service and replacing the singleton service’s endpoint with the network address of the newly created pod.

12. The method of claim 1, wherein the singleton service’s endpoint is not initially in a persistent store, and wherein the method comprises initially starting up each pod of the multiple pods which comprises:
determining, by a sidecar in each pod, whether the singleton service’s endpoint is in the persistent store;
in response to the sidecar in one pod determining that the singleton service’s endpoint is not in the persistent store, the sidecar in the one pod writing the network address of the one pod in the persistent store as the singleton service’s endpoint; or
in response to the sidecar in one pod determining that the singleton service’s endpoint is in the persistent store, the sidecar in the one pod not writing the network address of the one pod in the persistent store as the singleton service’s endpoint.

13. A computer program product, comprising one or more computer readable storage media storing computer readable program instructions, said program instructions executable by one or more processors of a computer system to cause the computer system to perform operations for dynamically changing an endpoint of a singleton service, said operations comprising:
determining that a first pod of multiple pods is unavailable;
ascertaining that the singleton service’s endpoint is a network address of the first pod; and
in response to said ascertaining, selecting a second pod of the multiple pods as a next provider of the singleton service and replacing the singleton service’s endpoint with the network address of the second pod.

14. The computer program product of claim 13, wherein a heartbeat is sent periodically, by a sidecar in each pod, to the sidecar in each other pod in accordance with a heartbeat interval and is received by the sidecar in each other pod in accordance with a timeout setting, wherein said determining that the first pod is unavailable comprises:
determining, from the received heartbeats, that the first pod is unavailable.

15. The computer program product of claim 14, wherein the sidecar in one pod of the multiple pods determines from the received heartbeats that the first pod is unavailable, wherein the sidecar in the one pod performs both said selecting the second pod as the next provider of the singleton service and said replacing the singleton service's endpoint with the network address of the second pod.

16. The computer program product of claim 13, wherein said selecting the second pod comprises:
determining that the second pod is an available pod having a highest priority of all available pods of the multiple pods.

17. A computer system, comprising one or more processors, one or more memories, one or more computer readable storage media, and computer readable program instructions stored on the one or more computer readable storage media for execution by the one or more processors via the one or more memories to cause the computer system to perform operations for dynamically changing an endpoint of a singleton service, said operations comprising:
determining that a first pod of multiple pods is unavailable;
ascertaining that the singleton service’s endpoint is a network address of the first pod; and
in response to said ascertaining, selecting a second pod of the multiple pods as a next provider of the singleton service and replacing the singleton service’s endpoint with the network address of the second pod.

18. The computer system of claim 17, wherein a heartbeat is sent periodically, by a sidecar in each pod, to the sidecar in each other pod in accordance with a heartbeat interval and is received by the sidecar in each other pod in accordance with a timeout setting, wherein said determining that the first pod is unavailable comprises:
determining, from the received heartbeats, that the first pod is unavailable.

19. The computer system of claim 17, wherein the operations further comprise:
determining that the singleton service’s endpoint in a persistent store has changed and in response, performing a hot reload that obtains the changed singleton service’s endpoint from the persistent store and connects the changed singleton service’s endpoint to the singleton service.

20. The computer system of claim 17, wherein the singleton service’s endpoint is not initially in the persistent store, and wherein the operations comprise initially starting up each pod of the multiple pods which comprises:
determining, by the sidecar in each pod, whether the singleton service’s endpoint is in the persistent store;
in response to the sidecar in one pod determining that the singleton service’s endpoint is not in the persistent store, the sidecar in the one pod writing the network address of the one pod in the persistent store as the singleton service’s endpoint; or
in response to the sidecar in one pod determining that the singleton service’s endpoint is in the persistent store, the sidecar in the one pod not writing the network address of the one pod in the persistent store as the singleton service’s endpoint.
